(19) United States
(12) Patent Application Publication
(10) Pub. No.: US 2012/0170113 A1
(43) Pub. Date: Jul. 5, 2012

(54) Infrared transmission optics formed with anti-reflection pattern, and manufacturing method thereof

(75) Inventor: Shinill Kang, Seoul (KR)

(73) Assignee: INDUSTRY-ACADEMIC COOPERATION FOUNDATION YONSEI UNIVERSITY, Seoul (KR)

(21) Appl. No.: 13/374,332

(22) Filed: Dec. 22, 2011

(30) Foreign Application Priority Data
Dec. 30, 2010 (KR) 10-2010-0139047

(51) Int. Cl. G02B 1/11; G02B 1/10

(52) U.S. Cl. 359/350; 216/11

(57) ABSTRACT

An infrared transmission optics formed with an anti-reflection pattern is provided. The infrared transmission optics is manufactured in the steps of i) applying a PR layer on the surface of an optics plate, ii) manufacturing an etching barrier pattern of a sinusoidal wave shape on the PR layer, and iii) manufacturing a pattern of a projection form on the plate where the etching barrier pattern is formed, through an etching process.

### CROSS REFERENCE TO RELATED APPLICATION

This application claims the benefit under 35 U.S.C. 119(a) of Korean Patent Application No. 10-2010-0139047, filed on Dec. 30, 2010, the disclosure of which is incorporated by reference in its entirety for all purposes.

### BACKGROUND OF THE INVENTION

1. Field of the Invention

The present invention relates to an infrared transmission optics formed with an anti-reflection pattern and a manufacturing method thereof, and more specifically, to an infrared transmission optics formed with an anti-reflection pattern, which is manufactured in the steps of i) applying a PR layer on the surface of an optics plate, ii) manufacturing an etching barrier pattern of a sinusoidal wave shape on the PR layer, and iii) manufacturing a pattern of a projection form on the plate where the etching barrier pattern is formed, through an etching process.

2. Background of the Related Art

Conventional anti-reflection (AR) techniques for increasing the amount of incident light by improving transmittance of an optics such as a lens, a window, a filter or the like generally include an anti-reflection film coating method and anti-reflection pattern coating method.

The anti-reflection film coating method improves transmittance by coating a surface of an optics with a dielectric material film having a thickness of λ/4, in which a square of a refractive index is the same as multiplication of refractive indexes of air and a lens, and the anti-reflection pattern coating method improves the transmittance by coating the surface of an optics with a grating pattern manufactured using a material having a refractive index similar to that of the optic.

However, such a conventional AR coating is mostly configured as a multi-layer coating, and thus manufacturing costs are high. In addition, since the coating should be performed after manufacturing a pattern, it takes a long time to process. Furthermore, coating materials are severely limited, and durability of the optics is lowered due to the coating.

Therefore, an infrared transmission optics is developed in the present invention, which does not use a conventional AR coating method and forms a pattern directly on the optics manufactured using a single material capable of transmitting infrared, such as silicon or germanium, thereby enhancing durability of the optics, simplifying a manufacturing process, and reducing manufacturing costs.

### SUMMARY OF THE INVENTION

Therefore, the present invention has been made in view of the above problems, and it is an object of the present invention to provide an infrared transmission optics and a manufacturing method thereof, for enhancing durability of the optics, simplifying a manufacturing process, reducing manufacturing costs without using a coating material, and remarkably increasing transmittance in the infrared region.

To accomplish the above object, according to one aspect of the present invention, there is provided an infrared transmission optics formed with an anti-reflection pattern, in which a pattern of a projection form is formed on the surface in order to improve transmittance in the infrared region. The optics may be a lens, a window, or a filter.

At this point, the pitch of the pattern is preferably 1 to 5 μm, and the wavelength of the infrared region is preferably 8 to 12 μm.

In addition, the optics may be manufactured using a single material capable of transmitting infrared, and the single material may be silicon or germanium.

Meanwhile, the infrared transmission optics formed with an anti-reflection may be manufactured in the steps of: i) applying a PR layer on the surface of an optics plate; ii) manufacturing an etching barrier pattern of a sinusoidal wave shape on the PR layer; and iii) manufacturing a pattern of a projection form on the plate where the etching barrier pattern is formed, through an etching process.

At this point, the pattern of a projection form may be formed on both sides of the optics by repeating the steps i) to iii) on the opposite side of the optics formed with the pattern, and before applying the PR layer on the opposite side of the optics, the side formed with the pattern may be coated with a protection film, and a CMP process may be performed on the opposite side of the optics formed with the pattern.

In addition, there may be a variety of methods capable of forming the etching barrier pattern of a sinusoidal wave shape, and the etching barrier pattern is preferably formed in any one of methods including laser ablation, direct electron beam writing, laser interference lithography, photolithography, thermal imprinting, and UV imprinting.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a view showing the process of manufacturing an infrared transmission optics formed with an anti-reflection pattern according to the present invention.

FIG. 2 is a view showing the concept of manufacturing a sinusoidal etching barrier pattern using laser ablation.

FIG. 3 is a view showing the concept of manufacturing a sinusoidal etching barrier pattern using electron beam direct writing.

FIG. 4 is a view showing the concept of manufacturing a sinusoidal etching barrier pattern using laser interference lithography.

FIG. 5 is a view showing the concept of manufacturing a sinusoidal etching barrier pattern using photolithography.

FIG. 6 is a view showing the concept of manufacturing a sinusoidal etching barrier pattern using high temperature imprinting.

FIG. 7 is a view showing the concept of manufacturing a sinusoidal etching barrier pattern using UV imprinting.

FIG. 8 is a view showing a picture of the surface of an optics on which a sinusoidal etching barrier pattern is formed using laser interference lithography.

FIG. 9 is a view showing a picture of the surface of an optics after etching the surface of the optics that is formed with a sinusoidal etching barrier pattern.

FIG. 10 is a view showing a picture of a surface coated with a film after a double side process is performed.

FIG. 11 is a view showing a picture of the final patterned surface after a double side process is performed.

FIG. 12 shows a graph comparing transmittance of an optics without forming a pattern, an optics formed with a single side pattern, and an optics formed with a double side pattern.

FIG. 13 is a view showing a result of a transmittance simulation according to the pattern pitch and height of an optics formed with a single side pattern at an irradiation wavelength of 8 μm.

FIG. 14 is a view showing a result of a transmittance simulation according to the pattern pitch and height of an optics formed with a single side pattern at an irradiation wavelength of 9.5 μm.

FIG. 15 is a view showing a result of a transmittance simulation according to the pattern pitch and height of an optics formed with a single side pattern at an irradiation wavelength of 12 μm.

FIG. 16 is a view showing a result of a transmittance simulation according to the pattern pitch and height of an optics formed with a double side pattern at an irradiation wavelength of 8 μm.

FIG. 17 is a view showing a result of a transmittance simulation according to the pattern pitch and height of an optics formed with a double side pattern at an irradiation wavelength of 9.5 μm.

FIG. 18 is a view showing a result of a transmittance simulation according to the pattern pitch and height of an optics formed with a double side pattern at an irradiation wavelength of 12 μm.

### DETAILED DESCRIPTION OF THE PREFERRED EMBODIMENT

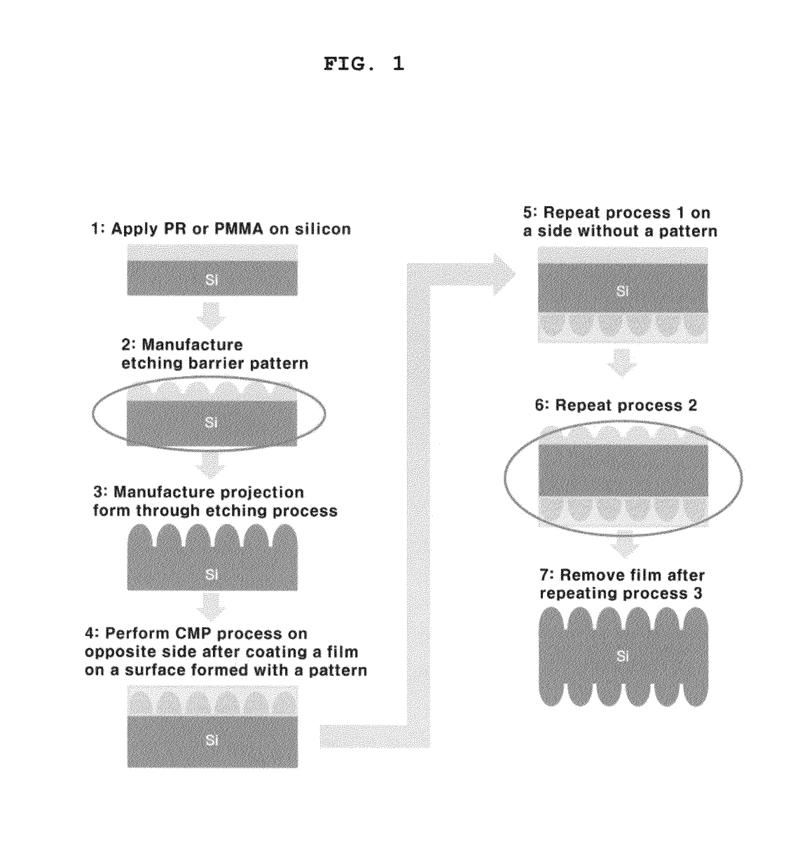

An infrared transmission optics according to the present invention is formed with a pattern of a projection form, and as shown in FIG. 1, the pattern of a projection form may be manufactured in the steps of i) applying a PR layer on the surface of an optics plate, ii) manufacturing an etching barrier pattern of a sinusoidal wave shape on the PR layer, and iii) manufacturing a pattern of a projection form on the plate where the etching barrier pattern is formed, through an etching process. At this point, the optics may be a lens, a window, a filter or the like.

Since most of conventional AR techniques for improving transmittance of optics are accomplished using multi-layer coatings or performed in a method of coating a pattern after manufacturing the pattern, manufacturing costs are high, and manufacturing process is complex. Furthermore, there is a large limitation in selecting a coating material, and durability of the optics is lowered.

The infrared transmission optics according to the present invention does not use a conventional AR coating method and forms a pattern of a projection form directly on the optics manufactured using a single material capable of transmitting infrared. Therefore, the present invention may enhance durability of the optics and lower manufacturing costs by simplifying the manufacturing process.

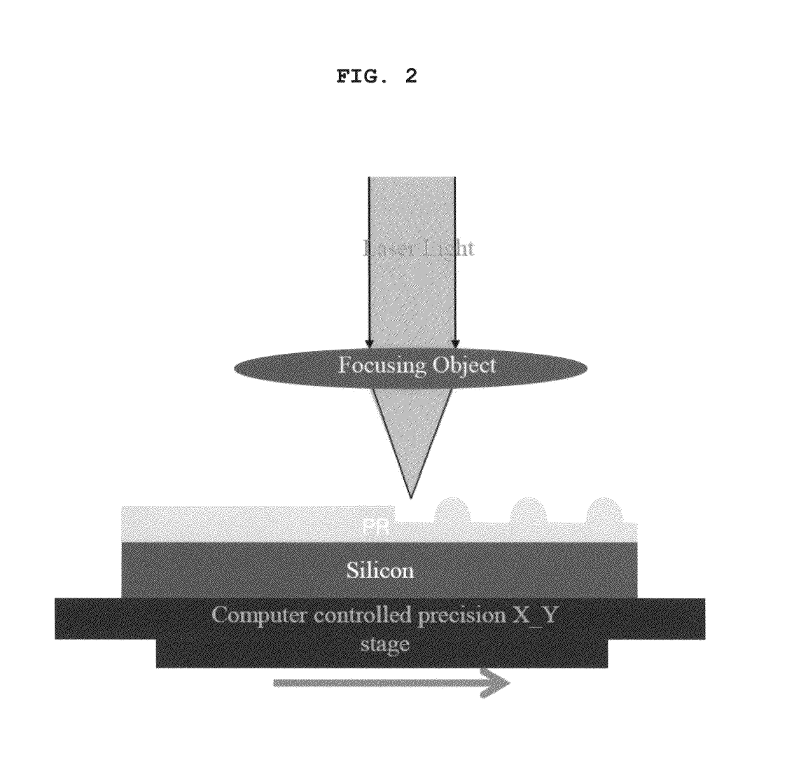

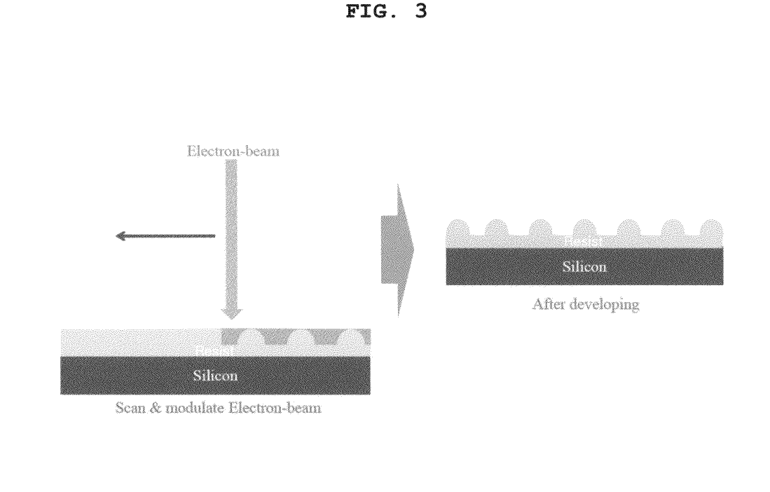

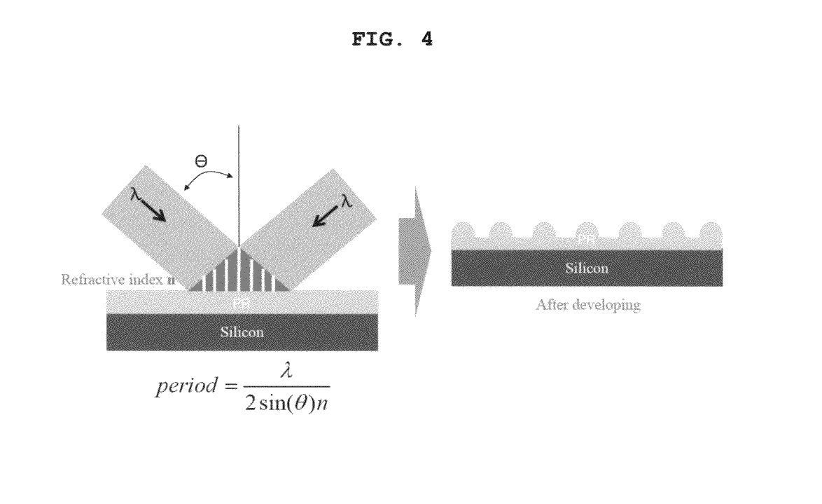

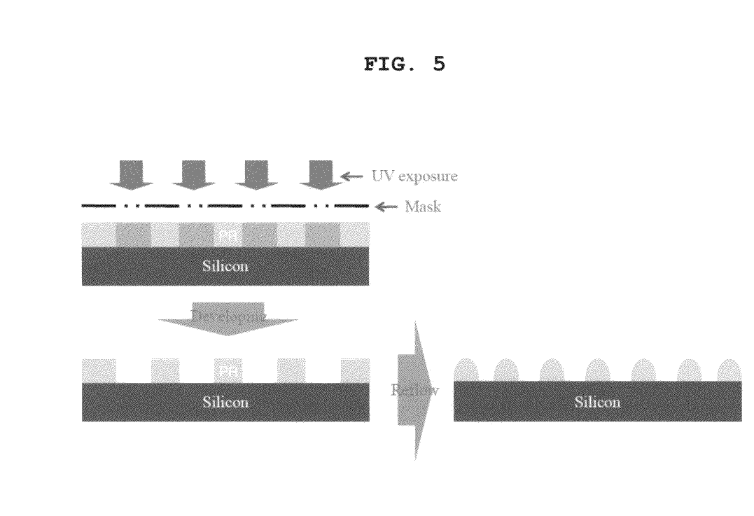

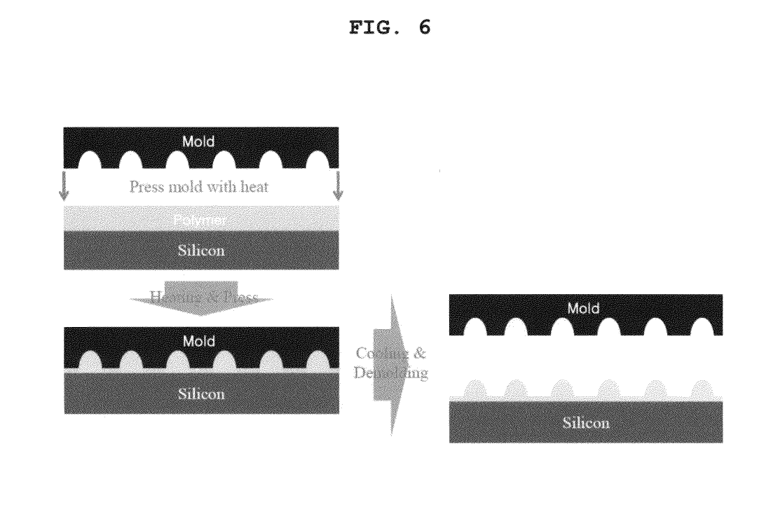

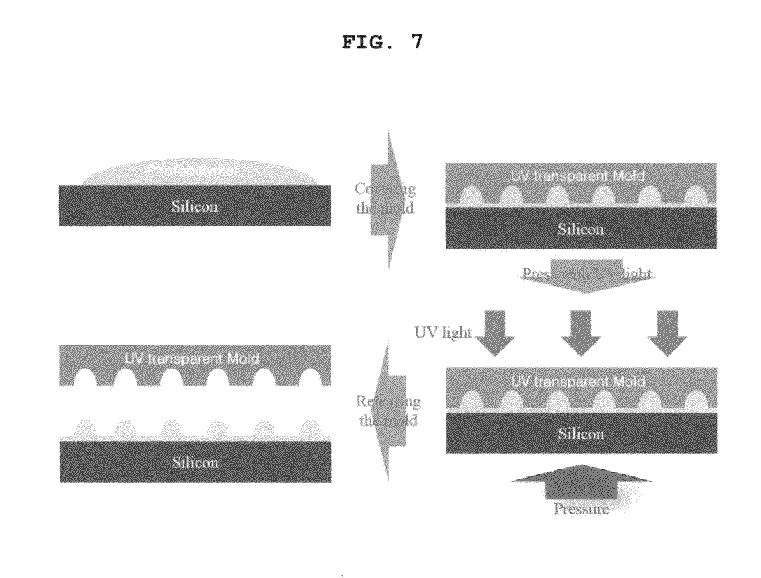

An etching barrier pattern is formed first in order to form a pattern directly on the surface of an optics plate, and the etching barrier pattern may be formed in a variety of methods as shown in FIGS. 2 to 7 and preferably formed in any one of methods including laser ablation (FIG. 2), direct electron beam writing (FIG. 3), laser interference lithography (FIG. 4), photolithography (FIG. 5), thermal imprinting (FIG. 6), and UV imprinting (FIG. 7).

Meanwhile, the pattern of a projection form may be formed on both sides of the optics by repeating the steps i) to iii) on the opposite side of the optics formed with the pattern. At this point, before forming the pattern on the opposite side, the side already formed with a pattern may be coated with a protection film, and then a chemical mechanical polishing (CMP) process may be performed on the opposite side of the optics formed with the pattern.

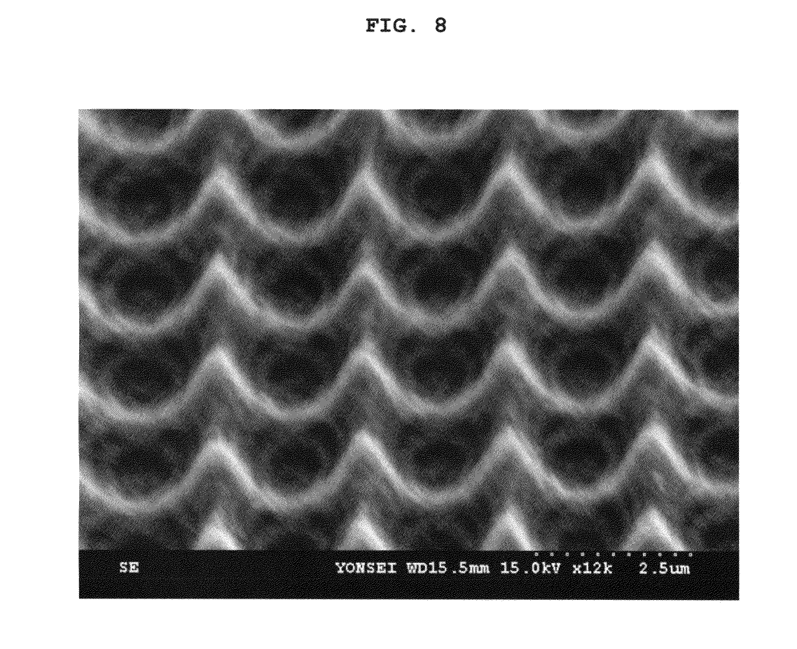

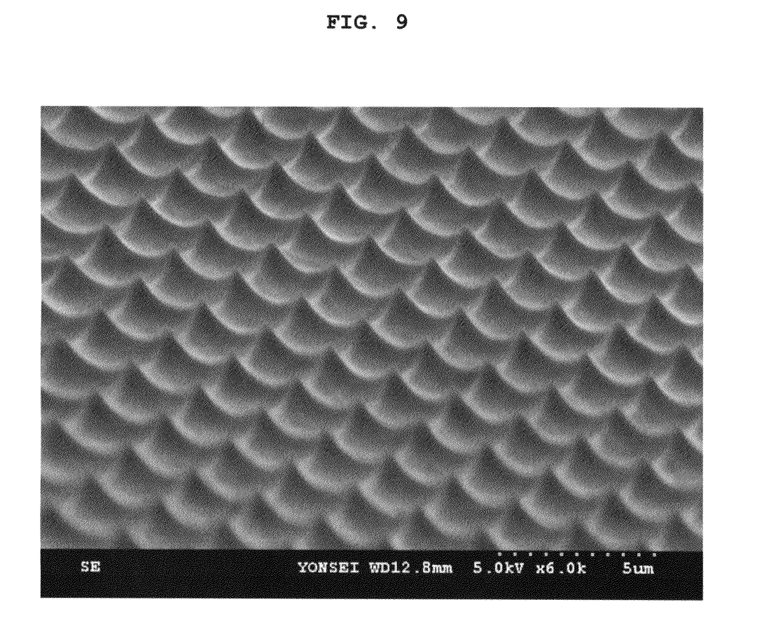

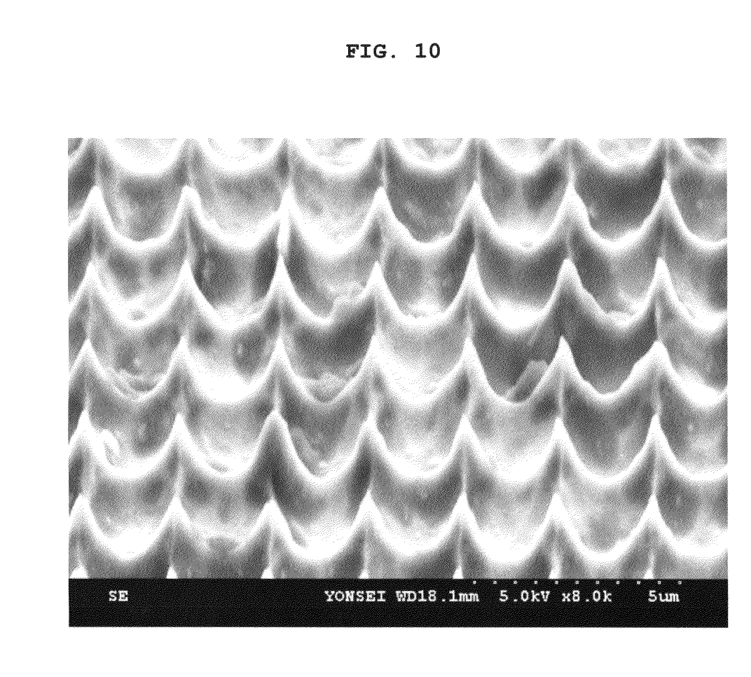

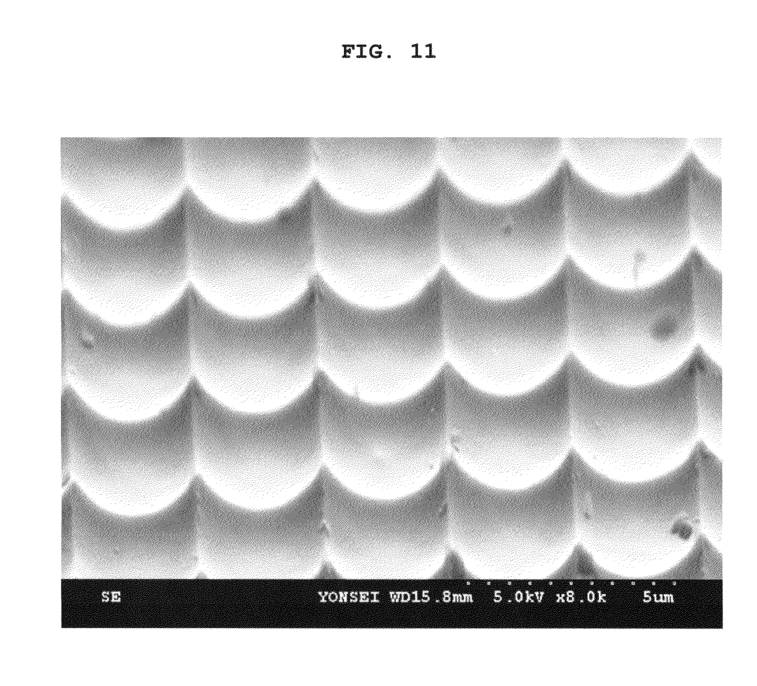

FIG. 8 shows the surface of an optics on which a sinusoidal etching barrier pattern is formed in a laser interference lithography method, and FIG. 9 is a view showing a picture of the surface of an optics after etching the surface of the optics that is formed with the etching barrier pattern. In addition, FIG. 10 is a view showing a picture of a surface coated with a film after a double side process is performed, and FIG. 11 is a view showing a picture of the final patterned surface after a double side process is performed. It is understood that a pattern of a projection form is also formed on both sides of the optics.

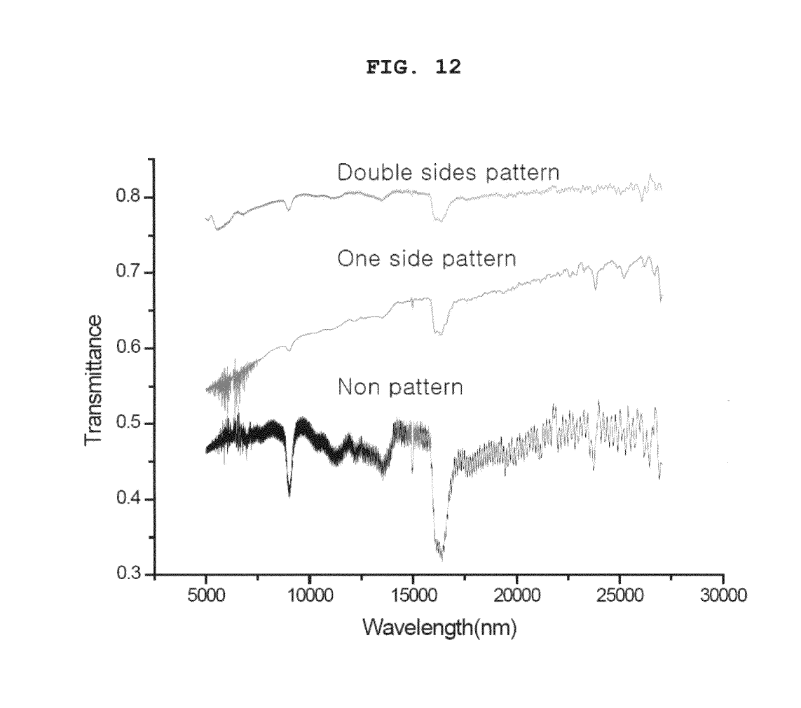

In addition, FIG. 12 shows a graph comparing transmittance of an optics without forming a pattern, an optics formed with a single side pattern, and an optics formed with a double side pattern. It is understood that transmittance is greatly improved when the pattern is formed on only one side of the optics compared with the optics where the pattern is not formed, and the transmittance is improved almost two time or more when the pattern is formed on both sides of the optics.

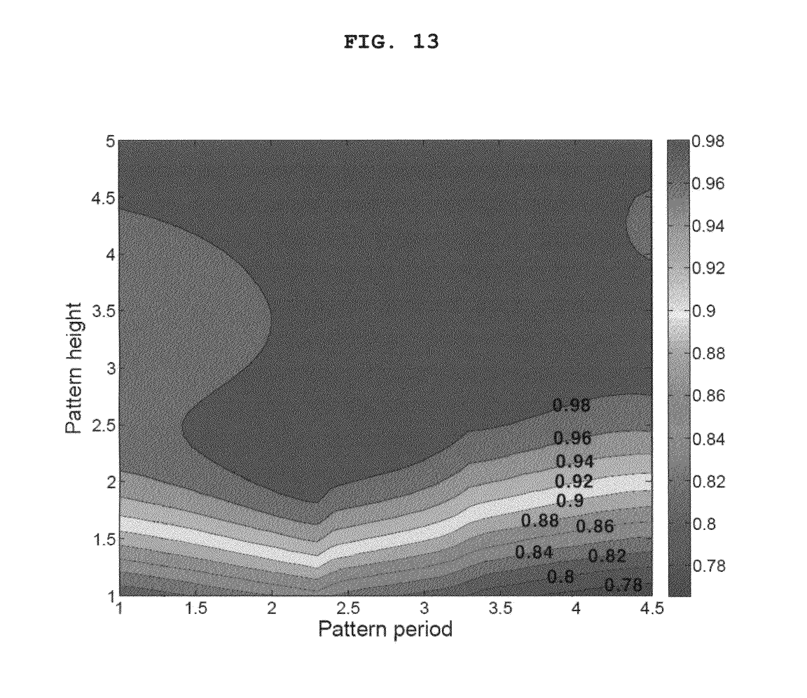

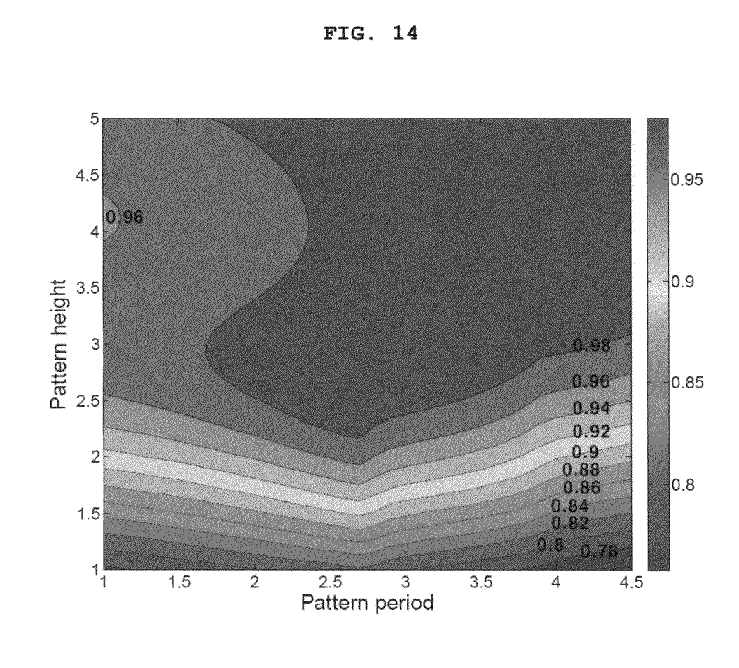

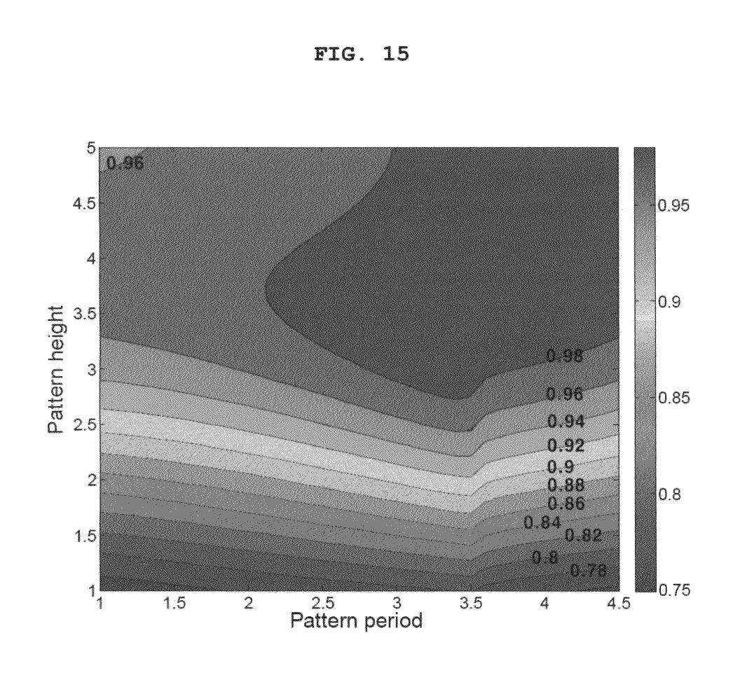

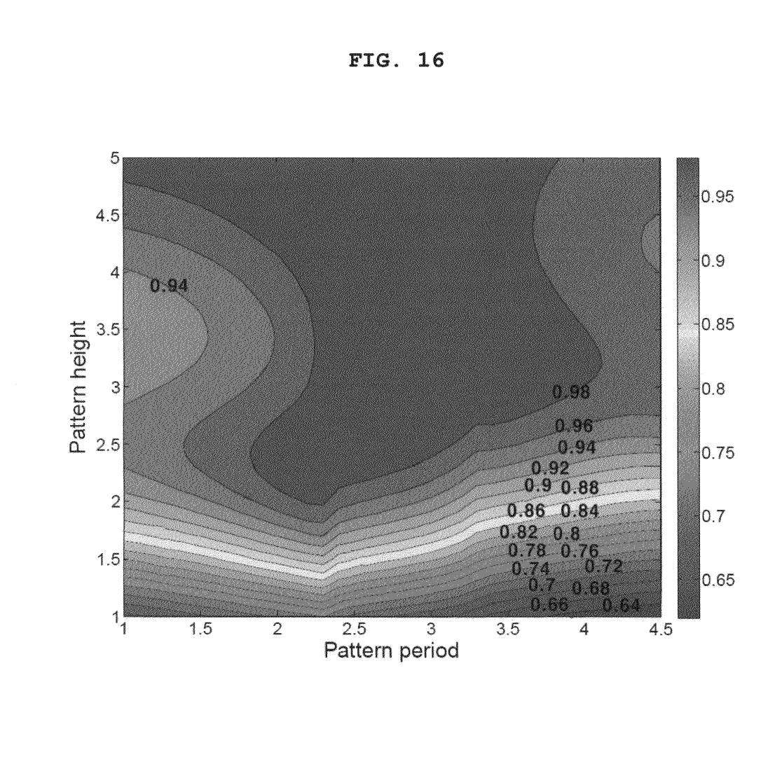

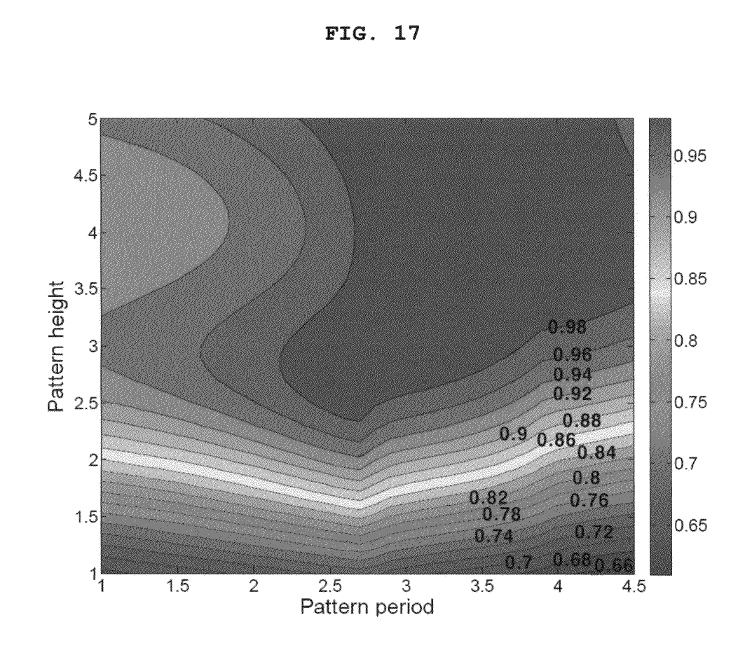

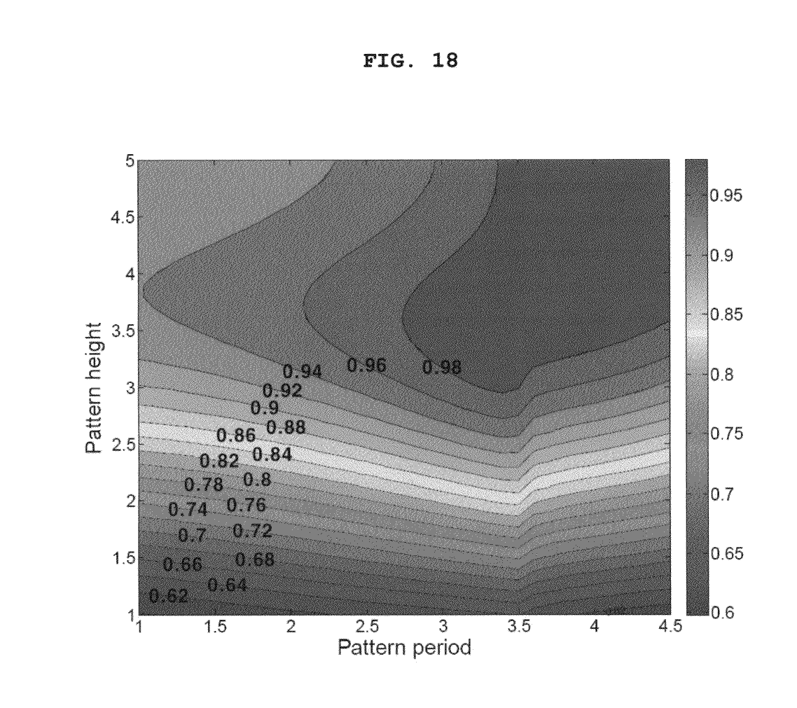

Meanwhile, FIGS. 13 to 15 are views respectively showing a result of a transmittance simulation according to a pattern pitch and height of an optics formed with a pattern on only one side at an irradiation wavelength of 8, 9.5 or 12 μm, and FIGS. 16 to 18 are views respectively showing a result of a transmittance simulation according to a pattern pitch and height of an optics formed with a pattern on both sides at an irradiation wavelength of 8, 9.5 or 12 μm.

As is observed from the simulation results, although the pitch of the pattern may be appropriately adjusted depending on the environment of using the optics, the pitch may be preferably 1 to 5 μm, and the wavelength of the infrared region penetrating the optics formed with an anti-reflection pattern of the present invention is preferably 8 to 12 μm.

As is described above, the infrared transmission optics formed with an anti-reflection pattern of the present invention does not use an additional coating material and forms a pattern directly on the surface of the optics using a variety of methods, and thus enhances durability of the optics, reduces manufacturing costs by simplifying the manufacturing process, and remarkably improves transmittance in the infrared region.

The infrared transmission optics formed with an anti-reflection pattern of the present invention does not use an additional coating material and forms a pattern directly on the surface of the optics, and thus enhances durability of the optics and simplifies the manufacturing process. Furthermore, since the coating material is not used, manufacturing costs can be reduced, and transmittance in the infrared region can be remarkably improved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An infrared transmission optics formed with an anti-reflection pattern, wherein a pattern of a projection form is formed on a surface in order to improve transmittance in an infrared region.

2. The optics according to claim 1, wherein the optics formed with the pattern of a projection form is a lens, a window, or a filter.

3. The optics according to claim 1, wherein a pitch of the pattern is 1 to 5 μm.

4. The optics according to claim 1, wherein a wavelength of the infrared region is 8 to 12 μm.

5. The optics according to claim 1, wherein the optics is manufactured using a single material capable of transmitting infrared.

6. The optics according to claim 5, wherein the single material is silicon or germanium.

7. A method of manufacturing an infrared transmission optics formed with an anti-reflection pattern, the method comprising the steps of:
i) applying a PR layer on a surface of an optics plate;
ii) manufacturing an etching barrier pattern of a sinusoidal wave shape on the PR layer; and
iii) manufacturing a pattern of a projection form on the plate where the etching barrier pattern is formed, through an etching process.

8. The method according to claim 7, wherein the pattern of a projection form is formed on both sides of the optics by repeating the steps i) to iii) on an opposite side of the optics formed with the pattern.

9. The method according to claim 8, wherein before applying the PR layer on the opposite side of the optics, the side formed with the pattern is coated with a protection film, and a CMP process is performed on the opposite side of the optics formed with the pattern.

10. The method according to claim 7, wherein the etching barrier pattern is formed in any one of methods including laser ablation, direct electron beam writing, laser interference lithography, photolithography, thermal imprinting, and UV imprinting.

11. The method according to claim 7, wherein the optics formed with the pattern of a projection form is a lens, a window, or a filter.

12. The method according to claim 7, wherein a pitch of the pattern is 1 to 5 μm.

13. The method according to claim 7, wherein a wavelength of the infrared region is 8 to 12 μm.

14. The method according to claim 7, wherein the optics is manufactured using a single material capable of transmitting infrared.

15. The method according to claim 13, wherein the single material is silicon or germanium.
